(19) United States
(12) Patent Application Publication
(10) Pub. No.: US 2015/0379969 A1
(43) Pub. Date: Dec. 31, 2015

(54) METHOD AND DEVICE FOR DISPLAYING A DESKTOP

(71) Applicant: Xiaomi Inc., Beijing (CN)

(72) Inventors: Guoquan ZHANG, Beijing (CN); Anyu LIU, Beijing (CN); Qiang WANG, Beijing (CN)

(73) Assignee: Xiaomi Inc.

(21) Appl. No.: 14/845,531

(22) Filed: Sep. 4, 2015

Related U.S. Application Data
(63) Continuation of application No. PCT/CN2013/090959, filed on Dec. 30, 2013.

(30) Foreign Application Priority Data
Mar. 11, 2013 (CN) 201310076032.5

(51) Int. Cl. G09G 5/30; G09G 5/02; G06F 3/0481

(52) U.S. Cl. CPC G09G 5/30; G06F 3/04817; G09G 5/02; G09G 2370/22; G09G 2320/08

(57) ABSTRACT

A method of displaying a desktop on a terminal, includes: determining a device type of a peripheral device connected to the terminal; and highlighting an application associated with the device type of the peripheral device on the desktop of the terminal.

### CROSS-REFERENCE TO RELATED APPLICATIONS

The present application is a continuation of International Application No. PCT/CN2013/090959, filed Dec. 30, 2013, which is based upon and claims priority to Chinese Patent Application No. 201310076032.5, filed Mar. 11, 2013, the entire contents of all of which are incorporated herein by reference.

### TECHNICAL FIELD

The present disclosure generally relates to computer technologies and, more particularly, to a method and a device for displaying a desktop.

### BACKGROUND

A terminal may be connected to different peripheral devices, for example, an earphone, a loudspeaker box, an on-board device and a universal serial bus (USB) device, etc. A user can connect a peripheral device to the terminal so as to use applications installed on the terminal. For example, the user connects an earphone to the terminal to listen to songs or view movies. Also for example, the user connects a USB device to the terminal for data transmission.

Conventionally, after a peripheral device is connected to the terminal, the terminal displays an icon or other identification in a display interface so as to inform the user that the peripheral device is successfully connected. The user may then find and start an application in the terminal that uses the peripheral device.

### SUMMARY

According to a first aspect of the present disclosure, there is provided a method of displaying a desktop on a terminal, comprising: determining a device type of a peripheral device connected to the terminal; and highlighting an application associated with the device type of the peripheral device on the desktop of the terminal.

According to a second aspect of the present disclosure, there is provided a terminal, comprising: a processor; and a memory for storing instructions executable by the processor; wherein the processor is configured to: determine a device type of a peripheral device connected to the terminal; and highlight an application associated with the device type of the peripheral device on a desktop of the terminal.

According to a third aspect of the present disclosure, there is provided a non-transitory computer-readable storage medium having instructions stored therein that, when executed by a processor of a terminal, cause the terminal to perform a method for displaying a desktop, the method comprising: determining a device type of a peripheral device connected to the terminal; and highlighting an application associated with the device type of the peripheral device on the desktop of the terminal.

It will be appreciated that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for displaying a desktop on a terminal, according to an exemplary embodiment.

FIG. 2 is a flowchart of a method for displaying a desktop on a terminal, according to an exemplary embodiment.

FIG. 3 is a flowchart of a method for displaying a desktop on a terminal, according to an exemplary embodiment.

FIG. 4 is a block diagram of an apparatus for displaying a desktop on a terminal, according to an exemplary embodiment.

FIG. 5 is a block diagram of an apparatus for displaying a desktop on a terminal, according to an exemplary embodiment.

FIG. 6 is a block diagram of an identifying sub-module, according to an exemplary embodiment.

FIG. 7 is a block diagram of an apparatus for displaying a desktop on a terminal, according to an exemplary embodiment.

FIG. 8 is a block diagram of a terminal, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with some aspects related to the invention as recited in the appended claims.

In exemplary embodiments, there is provided a method of displaying a desktop on a terminal, in which an application associated with a peripheral device connected to the terminal is highlighted on the desktop. As a result, a user can find the application quickly.

In the exemplary embodiments, the terminal is an electronic device, such as a desktop computer, a laptop, a mobile phone, a tablet computer and the like.

In the exemplary embodiments, a peripheral device is a device for connecting to the terminal to use. For example, a peripheral device can be an input device, an output device, an external memory, etc. The input device includes a keyboard, a mouse, a scanner, a web camera and the like. The output device includes a display, a printer, a loudspeaker box, an earphone and the like. The external memory includes an optical disk, a mobile hard disk, a USB flash disk and the like.

In the exemplary embodiments, an application is application software installed on the terminal. For example, the application may be an application software package or a user program.

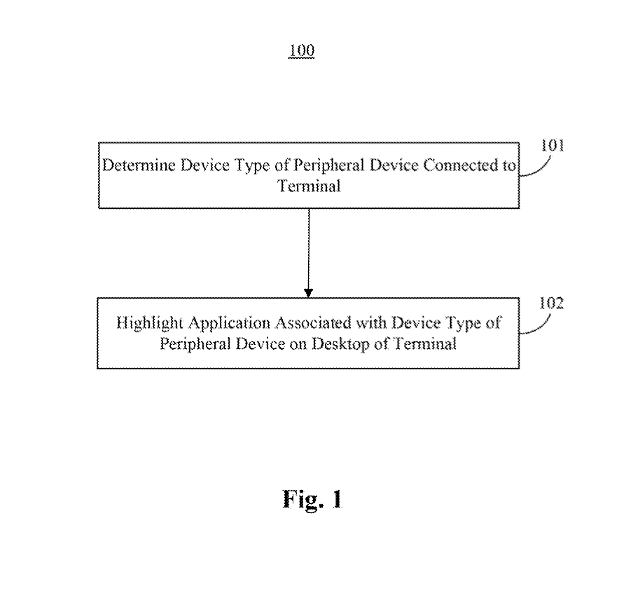

FIG. 1 is a flowchart of a method 100 for displaying a desktop on a terminal, according to an exemplary embodiment. Referring to FIG. 1, the method 100 includes the following steps.

In step 101, the terminal determines a device type of a peripheral device connected to the terminal.

In exemplary embodiments, different peripheral devices have different uses. After a peripheral device is connected to the terminal, the terminal can determine a device type of the peripheral device, so as to determine what type of peripheral device is connected.

In exemplary embodiments, peripheral devices may be classified on the basis of device types, for example, audio-visual devices, memory devices, and the like. The device types may be divided on the basis of functions or uses and the like, to which the present disclosure makes no restriction. For example, an earphone, a loudspeaker box, and the like may be determined to be audio-visual devices, and a USB flash disk, a mobile hard disk, and the like may be determined to be memory devices.

In step 102, the terminal highlights an application associated with the device type of the peripheral device on a desktop of the terminal.

In exemplary embodiments, after different peripheral devices are connected to the terminal, a user may use different applications installed on the terminal. For example, after an earphone is connected to the terminal, the user may use an audio player to play audio files or a video player to play video files. Also for example, after a printer is connected to the terminal, the user may use office software or picture processing software to print files and pictures, etc.

Accordingly, in the exemplary embodiments, after the device type of the peripheral device connected to the terminal is determined, the terminal may highlight, according to the device type, a corresponding type of applications on the desktop of the terminal. The highlighted applications are each an application in association with the device type of the peripheral device. For example, the association refers to an association relationship between the device type of the peripheral device and the application. The association relationship may be reflected by establishing a mapping or establishing an association list, and so on, such that one item in the mapping or the association list may be identified according to another item therein. For example, a corresponding application may be identified according to the device type of a peripheral device. For example, after an earphone is connected to the terminal, a device type of the earphone is determined to be an audio-visual device, and one or more applications associated with the earphone, e.g., an audio player or a video player, are identified. Also for example, after a printer is connected to the terminal, a device type of the printer is determined to be a memory device, and one or more applications associated with the printer, e.g., office software or picture processing software, are identified.

In exemplary embodiments, after an application associated with the device type of the peripheral device is identified, the terminal further highlights the application on the desktop. For example, the terminal highlights an application identification of the application. Also for example, the terminal configures a terminal visual theme associated with the device type of the peripheral device and highlights the application associated with the device type of the peripheral device in the terminal visual theme. Accordingly, the application identification of the application associated with the device type of the peripheral device is highlighted, and after the terminal is switched into the terminal visual theme, the highlighted application identification may be viewed.

In the exemplary embodiments, the application identification is an identification configured to trigger the startup of an application, for example, an application icon or a shortcut. The application may be triggered to start up through the application identification so that the user may use the application.

In the exemplary embodiments, the terminal visual theme is a display style of the terminal, including a display layout of items on the terminal, a display color style of the terminal, etc. For example, the terminal has a desktop and an application interface. The terminal can determine, based on the terminal visual theme, how to display the desktop and the application interface, and determine which color and background picture shall be applied to the desktop and the application interface.

In the exemplary embodiments, a desktop can be provided by an operating system of the terminal. The desktop is a display interface of the terminal by default. The application interface is an interface of an application, such as an address list application and so on.

In exemplary embodiments, a particular area on the desktop may be configured to display the application identification of an associated application. For example, an application area for a peripheral device may be partitioned off from an upper part of the desktop, and all applications associated with the device type of the peripheral device are displayed in the application area.

In exemplary embodiments, when the terminal is switched to a terminal visual theme including a display layout of the terminal and associated with the device type of a peripheral device, one or more corresponding application identifications may be displayed on the desktop according to the terminal visual theme. For example, if a background color of the desktop is black, a background color of the corresponding application identifications may be white, such that a part of application identifications is different from the desktop in background color. This part of application identifications are applications associated with the device type of the peripheral device.

By using the method 100, the user can conveniently find an application associated with the device type of a peripheral device on the desktop of the terminal. Applications associated with the device type of the peripheral device are displayed intuitively, which is convenient for the user to find and use the applications, thus saving time for the user.

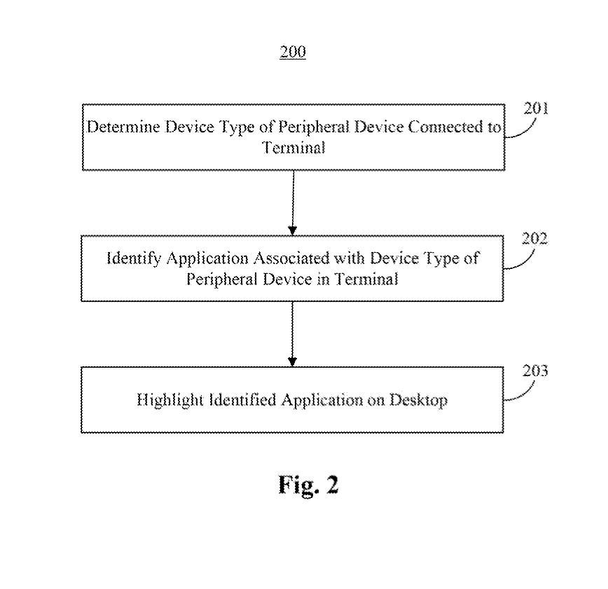

FIG. 2 is a flowchart of a method 200 for displaying a desktop on a terminal, according to an exemplary embodiment. Referring to FIG. 2, the method 200 includes the following steps.

In step 201, the terminal determines a device type of a peripheral device connected to the terminal.

In step 202, the terminal identifies an application associated with the device type of the peripheral device in the terminal.

In exemplary embodiments, after the device type of the peripheral device is determined, the terminal identifies an application associated with the peripheral device according to the device type, and further determines an application identification of the application so that the user may subsequently start the application using the application identification.

In exemplary embodiments, the terminal identifies one or more applications associated with the device type of the peripheral device according to a preset association relationship between device types and applications.

For example, to quickly identify one or more applications after the peripheral device is connected to the terminal, an association relationship between device types and applications may be preset, for example, by presetting audio-visual devices to be associated with audio and video players. In this manner, after the device type of the peripheral device connected to the terminal is determined, the terminal can quickly identify one or more applications associated the device type of the peripheral device by the association relationship.

In exemplary embodiments, to identify one or more applications associated with the device type of the peripheral device, the terminal checks an application type of each application in the terminal, and determines one or more applications corresponding to the application type that matches the device type of the peripheral device as the applications associated with the device type of the peripheral device.

In exemplary embodiments, different application types are determined according to different device types of peripheral devices, and each application in the terminal is configured to correspond to an application type.

In exemplary embodiments, applications installed on the terminal have different functions. On the basis of different functions, device types of peripheral devices associated with the respective applications are different. For example, some applications may configure sound for pictures and texts, and thus these applications may be associated with an earphone, a microphone, and other audio-visual devices. As another example, some applications may be camera applications with picture beautification functions, and thus these applications may be associated with printers or memory devices such as an external memory.

In the exemplary embodiments, to reduce time for manually finding an application by the user after a peripheral device is connected to the terminal, one or more applications associated with the device type of the peripheral device are preset. To determine the one or more applications associated with the peripheral device, an application type may be configured according to the device type of the peripheral device. For example, the application type may be an audio-visual application if the device type is an audio-visual device. As another example, the application type may be a data-transmission application if the device type is a data transmission device. In some embodiments, the application type is associated with the device type of the peripheral device, so that the application type may be identified by searching for the device type.

In exemplary embodiments, after it is determined which peripheral devices may be connected to the terminal and it is determined which applications are installed on the terminal, the applications are associated with the peripheral devices. For example, a mapping relationship or an association list between the applications and the peripheral devices is established. In this way, an associated application may be identified based on a corresponding peripheral device. After an application associated with a peripheral device is determined, display content corresponding to the application is determined for subsequent display. For example, an application identification of the application may be determined and saved together with the application in the association list.

In exemplary embodiments, when application types of applications in the terminal are configured, the applications may be classified on the basis of the application types. The terminal may be configured to make an automatic classification. For example, applications with audio and video playing or acquisition functions may be classified as audio-visual applications. As another example, applications with text and picture editing functions may be classified as data transmission applications.

In exemplary embodiments, each application may have diverse functions, and different users may use different functions of the same application. Accordingly, the terminal may receive user input to classify applications so as to meet different users' demands. In one exemplary embodiment, the terminal immediately informs the user of classifying a new application once the new application is installed on the terminal. In one exemplary embodiment, the terminal informs the user of classifying applications after a new application is installed, for example, by displaying a menu including classification selection when the user performs a long pressing of an application icon. In one exemplary embodiment, the terminal provides a special classification selection interface so that the user may select applications corresponding to each classification.

In exemplary embodiments, display contents corresponding to respective classified applications are determined. If the display contents are application identifications, each application corresponds to a different application identification.

In exemplary embodiments, device types may be associated with application types by using the form of an association list which includes application types and display contents of applications. An exemplary association list is shown in Table 1:

TABLE 1

| Device Type | Audio-Visual | | Data Transmission | | . . . | |
|---|---|---|---|---|---|---|
| Application | Audio-Visual | | Data Transmission | | . . . | |
| Type | | | | | | |
| Applications | Application | Display | Application | Display | Application | Display |
| | | Content | | Content | | Content |
| | Player | Icon | Office | Icon | . . . | . . . |
| | | | Software | | | |
| | Sound | Icon | Picture | Icon | . . . | . . . |
| | Recorder | | Beautification | | | |

Accordingly, based on an application type, the terminal can identify not only applications of the application type but also display contents of the applications, so as to identify application identifications corresponding to the applications from the display contents.

In the example of Table 1, device types, application types, applications and display contents are configured into the same association list. Accordingly, application types, applications, and application identifications can be identified from the association list through a device type, thus determining application identifications displayed on the terminal.

Therefore, when a peripheral device is connected to the terminal, the terminal can quickly identify an application type associated with the peripheral device according to preset application types, and further identify corresponding applications and application identifications thereof to highlight on the desktop, thus shortening time for the user to find applications and facilitating use of applications.

Still referring to FIG. 2, in step 203, the terminal highlights the identified application on the desktop.

In exemplary embodiments, after the application associated with the device type of the peripheral device is identified, the terminal highlights the application on the desktop of the terminal. For example, an application identification of the application is displayed so that the user may conveniently locate the application on the desktop and use the application identification to start the application.

In exemplary embodiments, when the application is highlighted, a display position or a background color may be changed for the application, so as to reduce lookup time for the user.

In one exemplary embodiment, the terminal highlights the application associated with the device type of the peripheral device by displaying the application in a set area of the desktop. For example, the application may be displayed on a main interface of the desktop, which is the main display interface of the desktop of the terminal and may be configured as a set area on the desktop. Also for example, the set area is set to occupy more than 50% of the desktop, and may be located at an upper part or a lower part (or other positions) of the desktop. As another example, if the desktop of the terminal is configured with a plurality of display pages, an additional display page can be added on the desktop. The additional display page will be displayed after the terminal is connected with the peripheral device, and the application associated with the device type of the peripheral device will be highlighted on the additional display page so as to facilitate use of the application.

Accordingly, the user may quickly identify the application from the set area and start the application. Furthermore, if there are more applications, the set area may be configured to display multiple pages if the terminal is unable to highlight all of these applications in the set area on one page.

In one exemplary embodiment, a highlighted identification is configured for the application associated with the device type of the peripheral device, and the application associated with the device type of the peripheral device and the highlighted identification are displayed together on the desktop.

In the exemplary embodiment, each device type is configured with a different highlighted identification. For example, an earphone may be configured with a picture like an earphone serving as a highlighted identification. As another example, a USB flash disk may be configured with a character “T” as a highlighted identification to indicate data transmission.

Therefore, highlighted identifications are configured for applications associated with the device type of the peripheral device. For example, a highlighted identification is configured for an application icon, and the highlighted identification and the application icon are displayed together on the desktop to show the application associated with the device type of the peripheral device. Thus, after the peripheral device is connected to the terminal, the user may quickly identify the application.

In one exemplary embodiment, a preset display color is configured for the application associated with the device type of the peripheral device, and the application is displayed on the desktop according to the preset display color.

In the exemplary embodiment, the preset display color includes a background color of an application identification and a font color of a name corresponding to the application identification. For example, if a main color of the desktop is blue, the background color of the application identification may be configured as yellow. In another example, when an application identification is an icon, the icon may be configured with a corresponding name for introduction of the application. The name of an application not associated with the peripheral device may be displayed in white on the desktop, while the name of the application associated with the peripheral device may be displayed in red on the desktop. Accordingly, the user may quickly identify the application based on the display color and start the application.

The above described methods for highlighting the application associated with the device type of the peripheral device on the desktop may be used individually or in combination. In practical implementations, other methods for highlighting the application can also be used, which are not limited in the present disclosure.

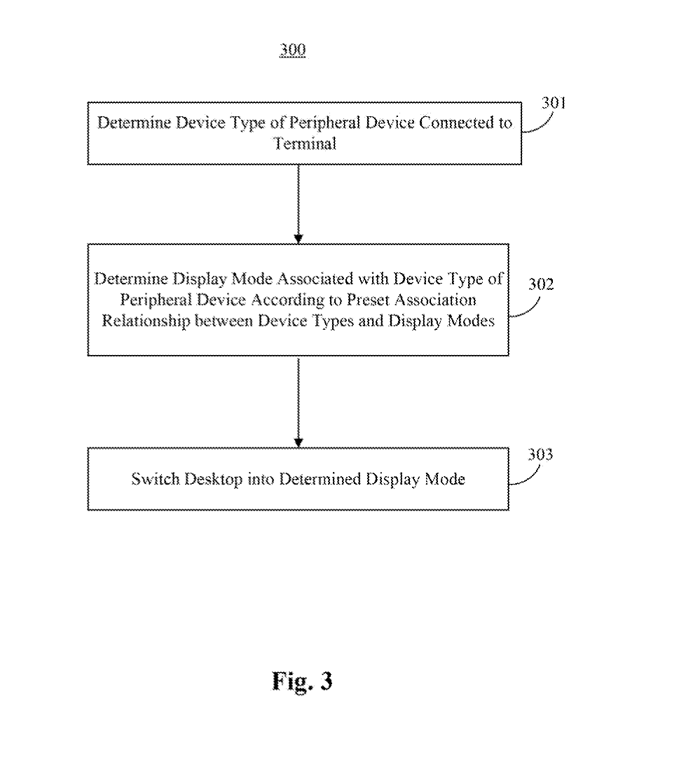

FIG. 3 is a flowchart of a method 300 for displaying a desktop on a terminal, according to an exemplary embodiment. Referring to FIG. 3, the method 300 includes the following steps.

In step 301, the terminal determines a device type of a peripheral device connected to the terminal.

In step 302, the terminal determines a display mode associated with the device type of the peripheral device according to a preset association relationship between device types and display modes. For example, in the determined display mode, an application associated with the device type of the peripheral device is highlighted, or only the application associated with the device type of the peripheral device is displayed.

In the exemplary embodiment, an association relationship between a device type and a display mode is preset so that after the device type of the peripheral device is determined, the terminal determines the display mode associated with the device type of the peripheral device. In the determined display mode, one or more applications associated with the device type of the peripheral device are highlighted, or only the applications associated with the device type of the peripheral equipment are displayed.

In exemplary embodiments, the display mode may be a terminal visual theme or a desktop layer under the terminal visual theme. For example, the terminal visual theme is a template for user interface (UI) resources that specify a visual appearance of a user interface by specifying elements of the user interface and properties of the elements. Also for example, the elements of the user interface include one or more of labels, menus, pictures, characters, backgrounds, and icons used in an operating system. The properties of the elements include one or more of a layout, locations, coloring, and shading etc. of the elements. Further for example, the desktop layer is a graphical display area that represents a virtual file management system, which includes one or more available applications. In the following description, it is assumed that the display mode is a terminal visual theme and in the terminal visual theme, one or more applications associated with the device type of the peripheral device are highlighted.

In the exemplary embodiment, the terminal visual theme is configured according to the device type of the peripheral device. For example, if the peripheral device is an audio-visual device, applications associated with the audio-visual device are highlighted in, e.g., terminal visual theme 1. The classification results may be in the form of an association list, to which the present disclosure makes no restriction. An exemplary association list is shown in Table 2.

TABLE 2

| Device Type | Audio-Visual | | Data Transmission | | . . . | |
|---|---|---|---|---|---|---|
| Terminal Visual | 1 | | 2 | | . . . | |
| Theme | | | | | | |
| Highlighted | Application | Display | Application | Display | Application | Display |
| Application | | Content | | Content | | Content |
| | Player | Icon, | Office | Icon, | . . . | . . . |
| | | Position, | Software | Position, | | |
| | | Color | | Color | | |
| | Sound | Icon, | Picture | Icon, | . . . | . . . |
| | Recorder | Position | Beautification | Position, | | |
| | | Color | | Color | | |

Similar to the description above in connection with the method 200 (FIG. 2), the terminal can perform one or more of the following methods to highlight an application associated with the device type of the peripheral device: 1) displaying the application associated with the device type of the peripheral device in a set area of the desktop; 2) configuring a highlighted identification for the application associated with the device type of the peripheral device, and displaying the application and the highlighted identification together on the desktop; and 3) configuring a preset display color for the application associated with the device type of the peripheral device and displaying the application on the desktop according to the preset display color.

In the example in Table 2, display contents include an application identification and a display mode. For example, an icon can serve as the application identification and in the display contents, the icon is configured with a display position and a background color to be displayed on the desktop.

In the exemplary embodiment, after the device type of the peripheral device connected to the terminal is determined, a corresponding terminal visual theme is determined according to the device type. For example, if the device type is an audio-visual device, the terminal determines terminal visual theme 1 based on the association list in Table 2.

Still referring to FIG. 3, in step 303, the terminal switches the desktop into the determined display mode.

In the present embodiment, if the peripheral device is disconnected from the terminal, the terminal automatically switches back to an original display mode before the peripheral device is connected to the terminal.

In one exemplary embodiment, one or more applications associated with the device type of the peripheral device are highlighted in the display mode. Therefore, the desktop may be switched to the display mode, and the applications may be highlighted on the desktop according to the display mode so as to facilitate the user locating and using the applications.

In one exemplary embodiment, the switched display mode only includes the applications associated with the device type of the peripheral device. Accordingly, the user may conveniently locate the applications associated with the device type of the peripheral device.

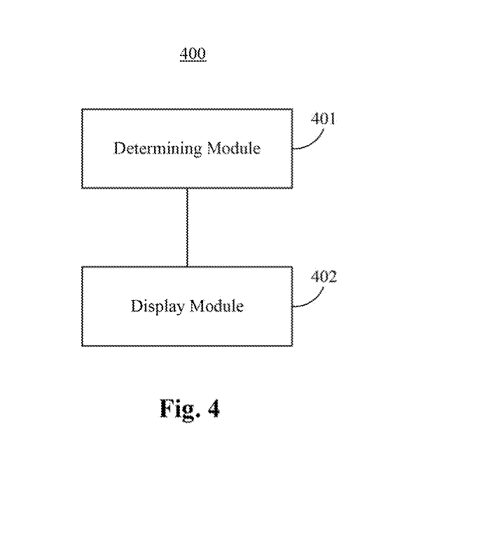

FIG. 4 is a block diagram of an apparatus 400 displaying a desktop on a terminal, according to an exemplary embodiment. For example, the apparatus 400 may be a part of the terminal or the whole terminal. Referring to FIG. 4, the apparatus 400 includes a determining module 401 configured to determine a device type of a peripheral device connected to the terminal; and a display module 402 configured to highlight an application associated with the device type of the peripheral device on the desktop of the terminal.

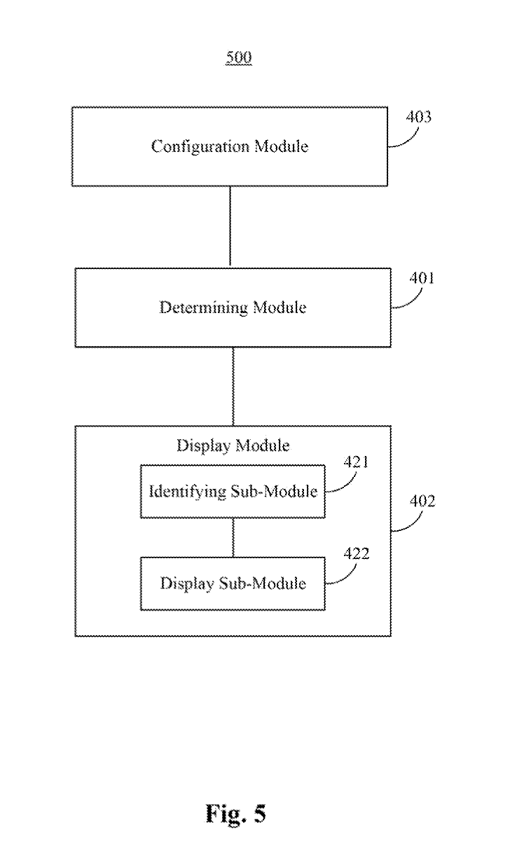

FIG. 5 is a block diagram of an apparatus 500 displaying a desktop on a terminal, according to an exemplary embodiment. For example, the apparatus 500 may be a part of the terminal or the whole terminal. Referring to FIG. 5, the apparatus 500 includes the determining module 401 and the display module 402 (FIG. 4).

In exemplary embodiments, the display module 402 further includes an identifying sub-module 421 configured to identify an application associated with the device type of the peripheral device in the terminal; and a display sub-module 422 configured to highlight the identified application on the desktop.

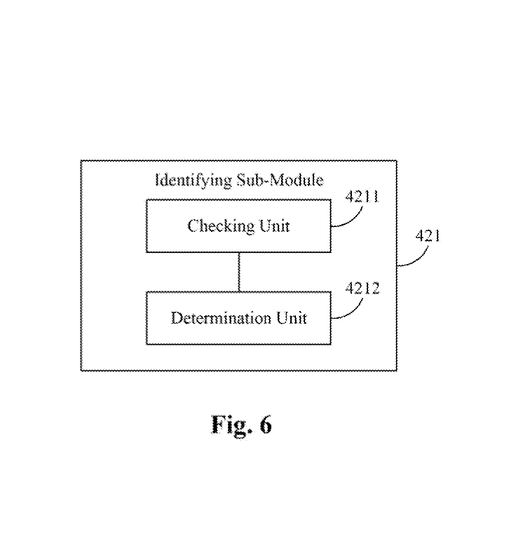

FIG. 6 is a block diagram of the identifying sub-module 421 (FIG. 5), according to an exemplary embodiment. Referring to FIG. 6, the identifying sub-module 421 includes a checking unit 4211 configured to check application types of a plurality of applications, respectively, in the terminal; and a determination unit 4212 configured to determine a first one of the applications corresponding to an application type that matches the device type of the peripheral device as the application associated with the device type of the peripheral device.

Referring back to FIG. 5, in one exemplary embodiment, the apparatus 500 also includes a configuration module 403 configured to determine application types according to device types of a plurality of peripheral devices, and to configure the applications to correspond to the application types in the terminal.

In one exemplary embodiment, the identifying sub-module 421 is configured to identify the application associated with the device type of the peripheral device according to a preset association relationship between device types and applications.

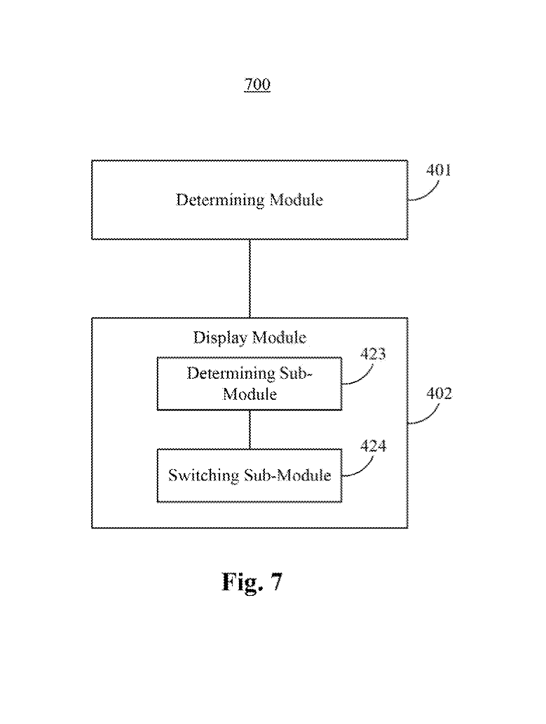

FIG. 7 is a block diagram of an apparatus 700 for displaying a desktop on a terminal, according to an exemplary embodiment. For example, the apparatus 700 may be a part of the terminal or the whole terminal. Referring to FIG. 7, the apparatus 700 includes the determining module 401 and the display module 402 (FIG. 4).

In exemplary embodiments, the display module 402 includes a determining sub-module 423 configured to determine a display mode associated with the device type of the peripheral device according to a preset association relationship between the device type and the display mode. In the determined display mode, an application associated with the device type of the peripheral device is highlighted, or only the application associated with the device type of the peripheral device is displayed.

The display module 402 also includes a switching sub-module 424 configured to switch the desktop to the determined display mode. The switching sub-module 424 is also configured to switch the desktop to an original display mode before the peripheral device is connected to the terminal, if the peripheral device is disconnected from the terminal.

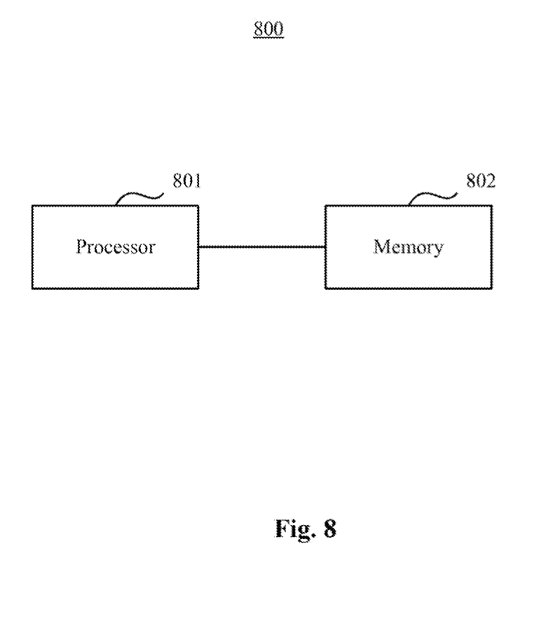

FIG. 8 is a block diagram of a terminal 800, according to an exemplary embodiment. Referring to FIG. 8, the terminal 800 includes a processor 801 configured to execute instructions to perform the above described methods, and memory resources represented by a memory 802, for storing the instructions and otherwise facilitating operation of the processor 801.

In exemplary embodiments, there is also provided a non-transitory computer readable storage medium including instructions, such as included in the memory 802, executable by the processor 801 in the terminal 800, for performing the above-described methods. For example, the non-transitory computer-readable storage medium may be a ROM, a random access memory (RAM), a compact disc read-only memory (CD-ROM), a magnetic tape, a floppy disc, an optical data storage device, or the like.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the disclosure will be apparent to those skilled in the art from consideration of the specification and practice of the disclosure disclosed herein. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the disclosure should only be limited by the appended claims.

What is claimed is:

1. A method of displaying a desktop on a terminal, comprising:
determining a device type of a peripheral device connected to the terminal; and
highlighting an application associated with the device type of the peripheral device on the desktop of the terminal.

2. The method of claim 1, wherein the highlighting comprises:
identifying the application associated with the device type of the peripheral device in the terminal; and
highlighting the identified application on the desktop of the terminal.

3. The method of claim 2, wherein the identifying comprises:
checking application types of a plurality of applications, respectively, in the terminal; and
determining a first one of the applications in the terminal corresponding to an application type that matches the device type of the peripheral device, as the identified application associated with the device type of the peripheral device.

4. The method of claim 3, further comprising:
determining the application types according to device types of a plurality of peripheral devices; and
configuring the plurality of applications to correspond to the application types, respectively, in the terminal.

5. The method of claim 2, wherein the identifying comprises:
identifying the application associated with the device type of the peripheral device according to a preset association relationship between device types and applications.

6. The method of claim 1, wherein the highlighting comprises:
determining a display mode associated with the device type of the peripheral device according to a preset association relationship between device types and display modes; and
switching the desktop into the determined display mode;
wherein in the determined display mode, the application associated with the device type of the peripheral device is highlighted, or only the application associated with the device type of the peripheral device is displayed.

7. The method of claim 6, further comprising:
switching the desktop into an original display mode before the peripheral device is connected to the terminal, if the peripheral device is disconnected from the terminal.

8. The method of claim 6, wherein the display mode is a terminal visual theme or a desktop layer.

9. The method of claim 1, wherein the highlighting comprises at least one of:
displaying the application associated with the device type of the peripheral device in a set area of the desktop;
configuring a highlighted identification for the application associated with the device type of the peripheral device, and displaying the application associated with the device type of the peripheral device together with the highlighted identification on the desktop; and
configuring a preset display color for the application associated with the device type of the peripheral device, and displaying the application associated with the device type of the peripheral device on the desktop according to the preset display color.

10. A terminal, comprising:
a processor; and
a memory for storing instructions executable by the processor;
wherein the processor is configured to:
determine a device type of a peripheral device connected to the terminal; and
highlight an application associated with the device type of the peripheral device on a desktop of the terminal.

11. The terminal of claim 10, wherein the processor is further configured to:
identify the application associated with the device type of the peripheral device in the terminal; and
highlight the identified application on the desktop of the terminal.

12. The terminal of claim 11, wherein the processor is further configured to:
check application types of a plurality of applications, respectively, in the terminal; and
determine a first one of the applications in the terminal corresponding to an application type that matches the device type of the peripheral device, as the application associated with the device type of the peripheral device.

13. The terminal of claim 12, wherein the processor is further configured to:
determine the application types according to device types of a plurality of peripheral devices; and
configuring the plurality of applications to correspond to the plurality of application types, respectively, in the terminal.

14. The terminal of claim 11, wherein the processor is further configured to:
identify the application associated with the device type of the peripheral device according to a preset association relationship between device types and applications.

15. The terminal of claim 10, wherein the processor is further configured to:
determine a display mode associated with the device type of the peripheral device according to a preset association relationship between device types and display modes; and
switch the desktop into the determined display mode;
wherein in the determined display mode, the application associated with the device type of the peripheral device is highlighted, or only the application associated with the device type of the peripheral device is displayed.

16. The terminal of claim 15, wherein the processor is further configured to:
switch the desktop into an original display mode before the peripheral device is connected to the terminal, if the peripheral device is disconnected from the terminal.

17. The terminal of claim 15, wherein the display mode is a terminal visual theme or a desktop layer.

18. The terminal of claim 10, wherein the processor is further configured to highlight the application associated with the device type of the peripheral device by performing at least one of:
displaying the application associated with the device type of the peripheral device in a set area of the desktop;
configuring a highlighted identification for the application associated with the device type of the peripheral device, and displaying the application associated with the device type of the peripheral device together with the highlighted identification on the desktop; and
configuring a preset display color for the application associated with the device type of the peripheral device, and displaying the application associated with the device type of the peripheral device on the desktop according to the preset display color.

19. A non-transitory computer-readable storage medium having instructions stored therein that, when executed by a processor of a terminal, cause the terminal to perform a method for displaying a desktop, the method comprising:
determining a device type of a peripheral device connected to the terminal; and
highlighting an application associated with the device type of the peripheral device on the desktop of the terminal.
